(19) United States
(12) Patent Application Publication
(10) Pub. No.: US 2015/0137697 A1
(43) Pub. Date: May 21, 2015

(54) INTEGRATED LIGHT SOURCE DRIVING CIRCUIT AND LIGHT SOURCE MODULE USING THE SAME

(71) Applicant: Beyond Innovation Technology Co., Ltd., Taipei City (TW)

(72) Inventor: Chien-Hsing Cheng, Taipei City (TW)

(21) Appl. No.: 14/322,926

(22) Filed: Jul. 3, 2014

(30) Foreign Application Priority Data
Nov. 19, 2013 (TW) 102142131

(51) Int. Cl. H05B 33/08

(52) U.S. Cl. CPC H05B 33/0803
USPC 315/291

(57) ABSTRACT

An integrated light source driving circuit including a power transistor, a driving chip and a diode and a light source module using the same are provided. The power transistor includes a substrate, first and second active regions, a gate region and an isolation region. The first and second active regions are disposed on two opposite sides of the substrate. The second active region and the gate region are disposed on the same side of the substrate. The isolation region is electrically connected to the first active region and electrically independent with/from the second active region and the gate region. The driving chip is stacked on the second active region and electrically connected to the gate region. The diode is disposed in the isolation region of the power transistor, where an anode of the diode is disposed toward the isolation region to be electrically connected to the first active region.

### CROSS-REFERENCE TO RELATED APPLICATION

This application claims the priority benefit of Taiwan application serial no. 102142131, filed on Nov. 19, 2013. The entirety of the above-mentioned patent application is hereby incorporated by reference herein and made a part of this specification.

### BACKGROUND OF THE INVENTION

1. Field of the Invention

The invention relates to a light source driving design, and more particularly to an integrated light source driving circuit and a light source module using the same.

2. Description of Related Art

A conventional light source driving circuit for driving a light emitting unit consists of circuit elements such as a driving chip, a power transistor, a diode and a resonant circuit, wherein the driving chip may provide a control signal to switch the power transistor to allow the light emitting unit to emit light through the current generated based on the switching of the power transistor.

In current light source driving circuit designs, among all the abovementioned circuit elements, only the driving chip is manufactured in an integrated manner due to its high circuit complexity, and the rest of the circuit elements are normally realized with a discrete element structure to assemble a light source driving circuit. In that case, however, the light source driving circuit takes up a greater area (i.e. layout area) in the light source module, which causes a negative impact on the designer's design freedom as well as the manufacturing costs of the product.

On the other hand, even if the abovementioned circuit elements are packaged together in an integrated manner, with known techniques, due to the restriction to the structures of the circuit elements such as the power transistor, driving chip and the diode, the designer can only make the circuit arrangement/layout on the same plane; accordingly, the layout area required for the overall light source driving circuit cannot be significantly reduced by integrating the abovementioned circuit elements through conventional integrating technology. Moreover, since a larger layout area is required for the chip when the light source driving circuit is integrated through the conventional integrated arrangement, the overall costs for packaging will increase significantly.

### SUMMARY OF THE INVENTION

The invention provides an integrated light source driving circuit and a light source module using the same, in which the circuit elements in the light source driving circuit are integrated together in a stacked manner.

In the invention, the integrated light source driving circuit is suitable or applied for driving a light emitting unit. The integrated light source driving circuit includes a power transistor, a driving chip, and a diode. The power transistor includes a substrate, a first active region, a second active region, a gate region, and an isolation region. The first active region and the second active region are disposed at two opposite sides of the substrate. The second active region and the gate region are disposed at the same side of the substrate. The isolation region and the first active region are electrically connected, and the isolation region is electrically independent from the second active region and the gate region. The driving chip is stacked on the second active region of the power transistor and electrically connected to the gate region. The diode is disposed in the isolation region of the power transistor, wherein an anode of the diode is disposed toward the isolation region to be electrically connected to the first active region.

In an embodiment of the invention, the power transistor is controlled by the driving chip to be electronically connected or electronically separated from the first active region and the second active region selectively.

In an embodiment of the invention, the substrate and the second active region have a corresponding opening which extends from the second active region and the substrate toward the first active region, wherein the isolation region is disposed in the opening.

In an embodiment of the invention, the opening is located in a central region of the power transistor, and the circumference of the opening is adjacent to the second active region and the substrate.

In an embodiment of the invention, the opening is located at a periphery region of the power transistor, and at least a side of the circumference of the opening is not adjacent to the second active region and the substrate.

In an embodiment of the invention, the power transistor further includes a termination region, which is disposed to encircle the substrate, the first active region and the second active region.

In an embodiment of the invention, the integrated light source driving circuit further includes a lead frame, which has a chip base and a plurality of pads. The plurality of pads are disposed around the chip base, wherein the power transistor is disposed on the chip base and the first active region is disposed toward the chip base.

In an embodiment of the invention, a cathode of the diode is electrically connected to at least a first one of the plurality of pads; the first active region is electrically connected to at least a second one of the plurality of pads, and the second active region is electrically connected to at least a third one of the plurality of pads.

In an embodiment of the invention, the power transistor is a vertical double-diffused MOS (VDMOS). The first active region is the drain of the VDMOS; the second active region is the source of the VDMOS; and the gate region is the gate of the VDMOS.

In an embodiment of the invention, the power transistor is an insulated gate bipolar transistor (IGBT). The first active region is the collector of the IGBT; the second active region is the emitter of the IGBT; and the gate region is the gate of the IGBT.

In the invention, the light source module includes an integrated light source driving circuit, a resonant circuit, and a light emitting unit. The integrated light source driving circuit includes a power transistor, a driving chip, and a diode. The power transistor includes a substrate, a first active region, a second active region, a gate region, and an isolation region. The first active region and the second active region are disposed at two opposite sides of the substrate. The second active region and the gate region are disposed at the same side of the substrate. The isolation region and the first active region are electrically connected, and the isolation region is electrically independent from the second active region and the gate region. The driving chip is stacked on the second active region of the power transistor and electrically connected to the gate region. The diode is disposed in isolation region of the power transistor, wherein the anode of the diode is disposed toward the isolation region to be electrically connected to the first active region. The resonant circuit is electrically connected to the anode of the diode and the first active region. The light emitting unit is electrically connected to the cathode of the diode.

Based on the above, the embodiments of the invention provide an integrated light source driving circuit and a light emitting module using the same. The integrated light source driving circuit may integrate a power transistor, a driving chip, and a diode together in a stacked manner, thereby reducing the overall packaging area required for the circuit so that that the design costs for the light emitting module may be effectively decreased.

To make the aforementioned and other features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a circuit of a light emitting module according to an embodiment of the invention.

FIGS. 2A-2C are structural schematic views illustrating an integrated light source driving circuit according to an embodiment of the invention.

FIG. 3 is a top view illustrating an integrated light source driving circuit according to an embodiment of the invention.

FIG. 4 is a top view illustrating an integrated light source driving circuit according to another embodiment of the invention.

### DESCRIPTION OF EMBODIMENTS

Embodiments of the invention provide an integrated light source driving circuit and a light emitting module using the same. The integrated light source driving circuit may integrate a power transistor, a driving chip, and a diode together in a stacked manner, thereby reducing the package area required for the overall circuit so that the design costs for the light emitting module may be effectively reduced. To make the disclosure of the invention more comprehensible, the following embodiments are illustrated as examples that can be truly implemented by the invention. Herein, wherever possible, elements/components/steps followed by same reference numbers in the drawings and descriptions refer to the same or like parts. Moreover, terms that indicate directions, such as “above”, “below”, “left”, “right” in the following embodiments are used in reference to directions in the accompanying drawings and are hence used for description but not for limiting the disclosure.

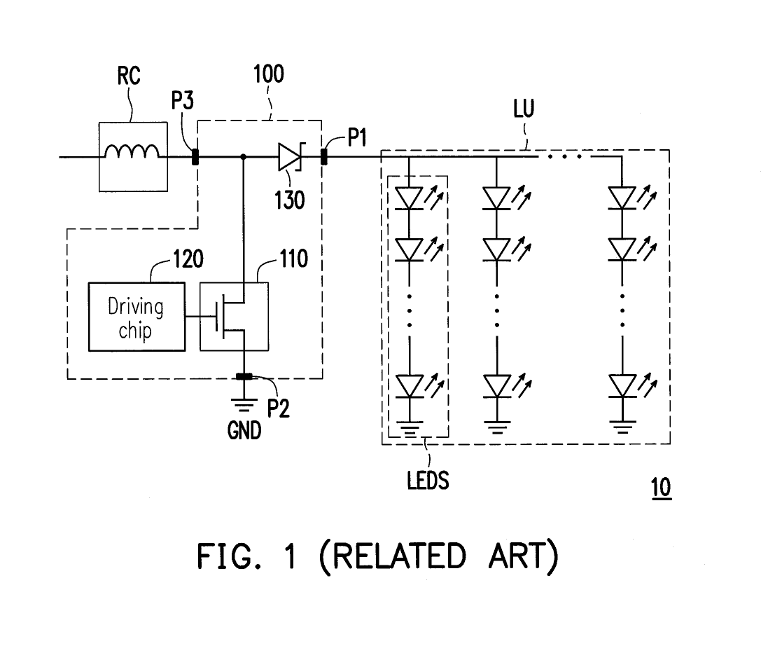

FIG. 1 is a schematic view illustrating a circuit of a light emitting module according to an exemplary embodiment of the invention. Please refer to FIG. 1. In the embodiment, a light emitting module 10 includes an integrated light source driving circuit 100, a resonant circuit RC and a light emitting unit LU.

In the embodiment, the integrated light source driving circuit 100 is formed by integrating a power transistor 110, a driving chip 120, and a diode 130. In the integrated light source driving circuit 100, a control terminal of the power transistor 110 is coupled to the driving chip 120, and a first terminal of the power transistor 110 is coupled to an anode of the diode 130. In addition, the integrated light source driving circuit 100 has at least three pins (e.g. P1, P2, P3) for being connected to the external circuit element(s), wherein a cathode of the diode 130 is coupled to the pin P1; the first terminal of the power transistor 110 and an anode of the diode 130 are mutually coupled to the pin P3; the second terminal of the power transistor 110 is coupled to the pin P2.

In terms of the overall circuit configuration of the light source module 10, the resonant circuit RC is coupled to the pin P3 of the integrated light source driving circuit 100 to be coupled to the first terminal of the power transistor 110 and the anode of the diode 130 through the pin P3. The light emitting unit LU is coupled the pin P1 of the integrated light source driving circuit 100 to be coupled to the cathode of the diode 130 via the pin P1. The pin P2 of the integrated light source driving circuit 100 is coupled to a ground GND.

In terms of the operation of the light source module 10, during the period when the light source module 10 is enabled, the driving chip 120 in the integrated light source driving circuit 100 provides a periodical control signal to control the on-state of the power transistor 110, allowing the resonant circuit RC to charge/discharge in response to the switching of the power transistor 110 so as to generate a stable driving current supplied to the light emitting unit LU through the diode 130. Accordingly, the light emitting unit LU may emit light in response to the driving current supplied by the integrated light source driving circuit 100.

Here, the resonant circuit RC in the embodiment may be, for example, a resonant tank formed of passive elements such as capacitor(s), inductor(s) and resistor(s); the light emitting unit LU may be, for example, a light emitting diode module formed of a plurality of light emitting diode strings LEDS connected in parallel, which should not be construed as a limitation to the invention. Moreover, in the integrated light source driving circuit 100, the diode 130 may be, for example, a schottky diode, a fast recovery diode, a super junction diode (SJ-diode), or a diode based on III-V group elements (such as GaAs, GaN, SiC), which also should not be construed as a limitation to the invention.

Specifically, in the embodiment of the invention, the power transistor 110 is realized by a transistor structure having a vertical diffusing characteristic (further explanations will be incorporated into the following embodiments). Based on the structural characteristic of the power transistor 110, the driving chip 120 and the diode 130 of the embodiment are disposed on the power transistor 110 in a stacked manner. In other words, in the embodiment of the invention, the integrated light source driving circuit 100 is packaged in a structure that the power transistor 110, the driving chip 120, and the diode 130 are stacked layer by layer.

In comparison with the package structure of a conventional light source driving circuit, since the light source driving circuit 100 formed in the stacked manner may save more packaging area, the freedom for circuit arrangement/design may further increase and the overall costs for the design and production of the light source module 10 may decrease correspondingly.

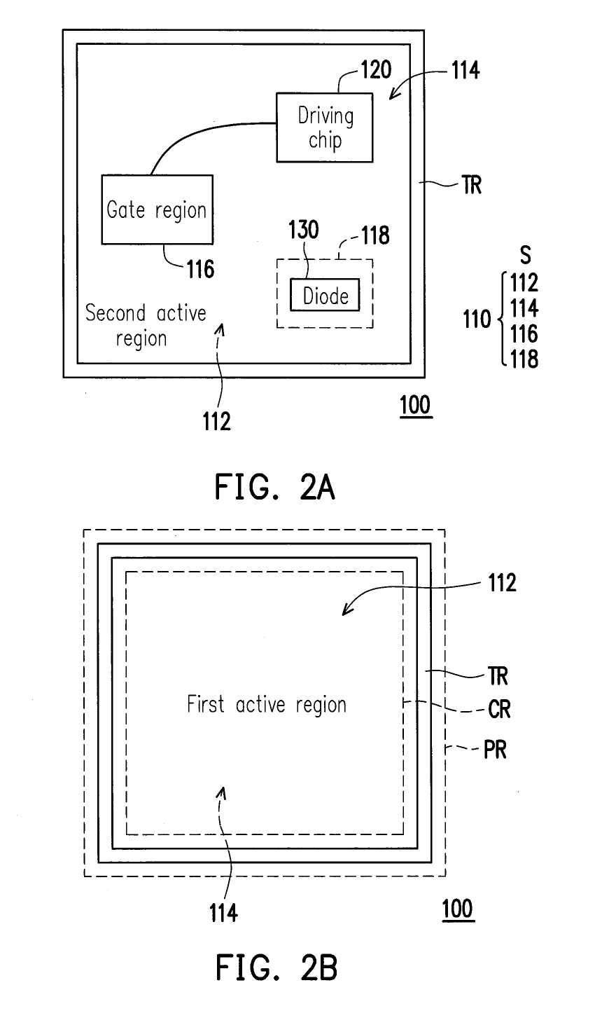

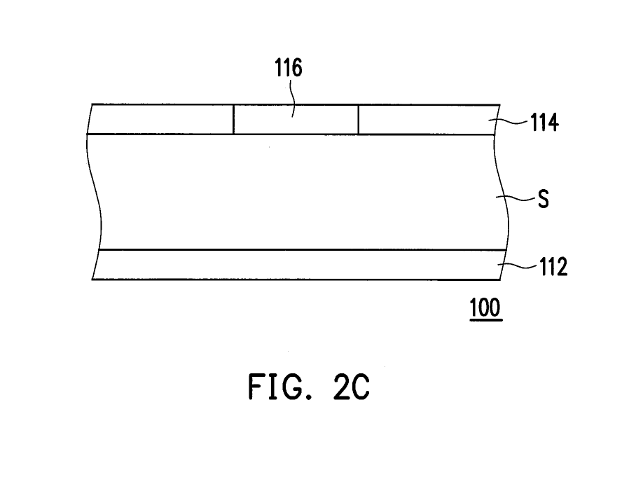

Embodiments for FIGS. 2A-2C are provided below for describing the structural configuration of the integrated light source driving circuit in the embodiments of the invention, wherein FIG. 2A illustrates a schematic top view of the integrated light source driving circuit 100; FIG. 2B illustrates a schematic bottom view of the integrated light source driving circuit 100; FIG. 2C illustrates a sectional schematic view of the integrated light source driving circuit 100.

Please refer to FIGS. 2A-2C. In the embodiment, the power transistor 110 includes a substrate S, a first active region 112, a second active region 114, a gate region 116, and an isolation region 118. The first active region 112 and the second active region 114 are disposed at two opposite sides of the substrate S (respectively located at the lower side and upper side of the substrate S as shown in FIG. 2C). The second active region 114 and the gate region 116 are disposed at the same side of the substrate S. The isolation region 118 is disposed in or around the second active region 112 (further descriptions will be incorporated into the following embodiments; the position shown here is for illustrative purposes only and therefore is drawn by a dashed-line frame). The isolation region 118 and the first active region 112 are electrically connected, and the isolation region 118 is electrically independent from the second active region 114 and the gate region 116. Apart from the abovementioned structural configuration, the power transistor 110 may further include a termination region TR used for distributing the effect of an electric field and disposed to encircle a stacked structure formed by the substrate S, the first active region 112, and the second active region 114.

The driving chip 120 is stacked on/at the second active region 114 of the power transistor 110 and electrically connected to the gate region 116 of the power transistor 110. The diode 130 is disposed/located in the isolation region 118 of the power transistor 110, wherein the anode of the diode 130 is disposed toward as well as leans against a surface where the isolation region 118 is electrically connected to the first active region 112 to be electrically connected to the first active region 112.

More specifically, in comparison with the schematic view of the circuit illustrated by FIG. 1, the first active region 112 corresponds to the first terminal of the power transistor 110; the second active region 114 corresponds to the second terminal of the power transistor 110; the gate region 116 corresponds to the control terminal of the power transistor 110. In other words, in the embodiment, the driving chip 120 may control the power transistor 110 to turn on/off periodically by establishing a channel between the active regions 112 and 114 so as to allow the first active region 112 and the second active region 114 to be selectively/periodically electrically connected or electrically separated, thereby enabling the power transistor 110 to turn on/off.

In an exemplary embodiment, the power transistor 110 may be, for example, a vertical double-diffused MOS (VDMOS). In the exemplary embodiment, the first active region 112 is the drain of the VDMOS; the second active region 114 is the source of the VDMOS; and the gate region 116 is the gate of the VDMOS.

In another exemplary embodiment, the power transistor 110 may also be, for example, an insulated gate bipolar transistor (IGBT). In the exemplary embodiment, the first active region 112 is the collector of the IGBT; the second active region 114 is the emitter of the IGBT; and the gate region 116 is the gate of the IGBT.

However, please note that the power transistor 110 of the invention is not limited to the abovementioned exemplary embodiments. Any transistor structures having the vertical diffusing characteristic (i.e. the structure that two electrodes for establishing a conductive channel are disposed at two sides of a substrate) may apply; therefore, the abovementioned exemplary embodiments should not be construed as a limitation to the invention. Moreover, the sectional structure of the integrated light source driving circuit 100 shown in FIG. 2C is a simple schematic view illustrating a relative configuration relation among the substrate S, the first active region 112, the second active region 114 and the gate region 116 in the power transistor 110, which should not be construed as a limitation to the specific sectional structure of the integrated light source driving circuit 100 of the invention.

For easy reference to the configuration relation described in the following embodiments, here, a region within the periphery of the power transistor 110 is defined as a central region CR (the region encircled by the inner dashed-line frame), and a region outside the periphery of the power transistor 110 is defined as a periphery region PR (the region encircled by two dashed-line frames). As shown in FIG. 2B, in the following embodiments, the descriptions about the central region CR and the periphery region PR, if any, are understood based on the above definition. In addition, in FIGS. 2A-2C, the relative configuration relation among regions 112-118 in the power transistor 110 is shown for illustrative purposes only, which should not be construed as a limitation to the invention.

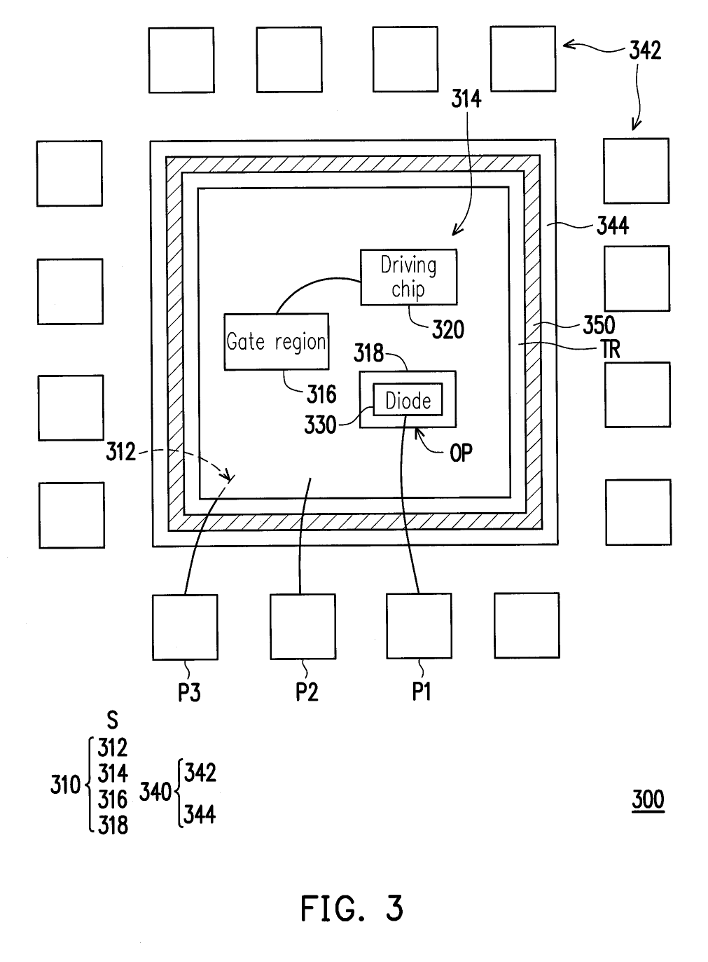

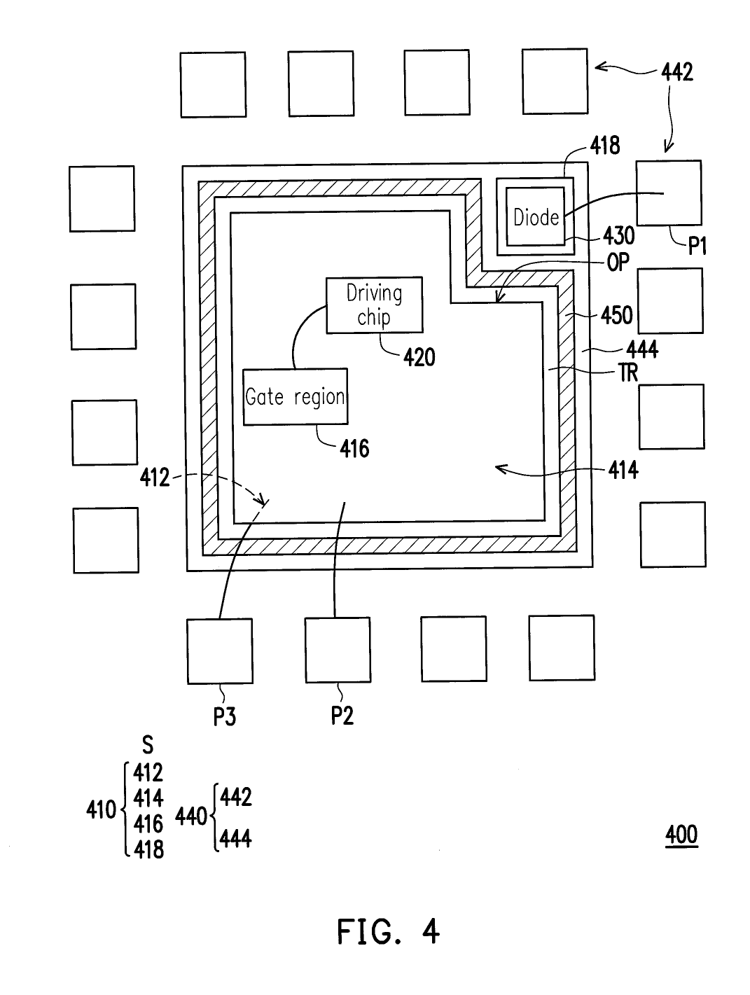

In the following embodiments, FIGS. 3-4 are provided as specific examples for implementation of the abovementioned integrated light source driving circuit, wherein FIGS. 3 and 4 are top views respectively illustrating the integrated light source driving circuit in different embodiments of the invention.

Please refer to FIG. 3 first. In the embodiment, the integrated light source driving circuit 300 not only includes a power transistor 310, a driving chip 320, a diode 330 but also a lead frame 340 and an isolation region 350, wherein the lead frame 340 includes a plurality of pads 342 (e.g. pads P1, P2, P3) and a chip base 344.

In the power transistor 340 of the embodiment, a relative configuration relation among the substrate S (not shown in the top view), the first active region 312, the second active region 314 and the gate region 316 is similar to the embodiment shown in FIG. 2. The pads 342 of the lead frame 340 are disposed around the chip base 344, and the power transistor 310 is disposed on the chip base 344 in the manner that the first active region 312 faces toward the chip base 344. The isolation region 350 is disposed to encircle the outer side of the termination region TR so as to block the electrical connection between the integrated light source driving circuit 300 and the external elements. In the embodiment, the pads 342 are exemplarily shown to be disposed at each side in an amount of four, which should not be construed as a limitation to the invention.

More specifically, in the power transistor 310 of the embodiment, the substrate S and the second active region 314 have a corresponding opening OP. The opening OP is located in the central region CR, and therefore the circumference of the opening OP is adjacent to the second active region 314 and the substrate S, and extends toward the first active region 112 from the second active region 314 and the substrate S sequentially (in the direction from the top to the bottom). In the embodiment, the isolation region 318 of the power transistor 310 is disposed in the opening OP.

In an exemplary embodiment, the isolation region 318 may be formed by applying an insulating material on the inner wall of the opening OP and coating a conductive epoxy on the surface (i.e. the surface of the first active region 312 exposed in the opening OP) of the bottom of the opening OP. Meanwhile, an anode of the diode 330 is disposed at the bottom of the opening OP so as to be electrically connected to the first active region 312 via the conductive epoxy at the bottom of the opening OP and to be electrically independent from the second active region 314 and the gate region 316 via the insulating material on the inner wall of the opening OP.

On the other hand, in the embodiment, the integrated light source driving circuit 300 may be electrically connected to the pads 342 via wire bonding or ribbon bonding so as to be electrically connected to the external electric elements via the corresponding pads 342. Please see the structure shown in FIG. 3 as an example. A cathode of the diode 330, the second active region 314 and the first active region 312 may be electrically connected to the corresponding pads P1, P2 and P3 respectively via wire bonding/ribbon bonding. In comparison with the circuit structure shown in FIG. 1, the pads P1, P2 and P3 correspond to the pins P1, P2 and P3 of the integrated light source driving circuit 100. In other words, in the embodiment, the cathode of the diode 330 is electrically connected to the light emitting unit LU via the pad P1. The first active region 312 is electrically connected to the resonant circuit RC via the pad P2, and the second active region 314 is electrically connected to the ground GND via the pad P3. Additionally, although it is shown that the diode 330, the second active region 314 and the first active region 312 are wire bonded/ribbon bonded to one of corresponding pads P1-P3 only, the invention is not limited thereto; same element/region may be wire bonded to a plurality of pads at the same time depending on the designer's requirements and concerns.

Please also refer to FIG. 4. An integrated light source driving circuit 400 includes a substrate S (not shown), a power transistor 410, a driving chip 420, a diode 430, a lead frame 440, and an isolation region 450, and the overall configuration is approximately similar to the integrated light source driving circuit 300 in the above embodiment, wherein the main difference between the two lies in the configuration of an isolation region 418.

Specifically, in the embodiment, an opening OP of the power transistor 410 is formed in a periphery region PR of the power transistor 410, and therefore at least one side of the circumference of the opening OP is not adjacent to the second active region 414 and the substrate S (the opening OP in the embodiment is formed at the upper right corner of the power transistor 410; however, the invention is not limited thereto). Here, the isolation region 418 (may be formed by, for example, a conductive epoxy) is directly electrically connected to the first active region 412 and may be regarded as a region separated from the second active region 420 and the substrate S. Therefore, the isolation region 418 will be electrically independent from the second active region 420 and the substrate S. In that case, an anode of the diode 430 may be disposed toward a surface of the isolation region 418 to be directly placed at the isolation region 418 vertically so as to be electrically connected to the first active region 312 via the isolation region 418.

In addition, similar to the embodiment for FIG. 3, the integrated light source driving circuit 400 in the embodiment may also be electrically connected to the pad 442 via wire bonding/ribbon bonding and electrically connected to external electrical elements via the corresponding pads 442 (e.g. pads P1, P2, P3).

Based on the above, the embodiments of the invention provide an integrated light source driving circuit and a light emitting module using the same. The integrated light source driving circuit may integrate the power transistor, the driving chip, and the diode together in the stacked manner so as to reduce the overall package area required for the circuit and allow the design costs of the light emitting module to decrease effectively.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An integrated light source driving circuit, comprising:
a power transistor comprising a substrate, a first active region, a second active region, a gate region, and an isolation region, the first active region and the second active region being disposed at two opposite sides of the substrate, the second active region and the gate region being disposed at a same side of the substrate, the isolation region and the first active region being electrically connected, and the isolation region being electrically independent from the second active region and the gate region;
a driving chip stacked on the second active region of the power transistor and electrically connected to the gate region; and
a diode disposed in an isolation region of the power transistor, wherein an anode of the diode is disposed toward the isolation region to be electrically connected to the first active region.

2. The integrated light source driving circuit according to claim 1, wherein the power transistor is controlled by the driving chip to be selectively electrically connected or electrically separated from the first active region and the second active region.

3. The integrated light source driving circuit according to claim 1, wherein the substrate and the second active region have a corresponding opening extending toward the first active region from the second active region and the substrate, wherein the isolation region is disposed in the opening.

4. The integrated light source driving circuit according to claim 3, wherein the opening is located in a central region of the power transistor, and a circumference of the opening is adjacent to the second active region and the substrate.

5. The integrated light source driving circuit according to claim 3, wherein the opening is located in a periphery region of the power transistor, and at least a side of a circumference of the opening is not adjacent to the second active region and the substrate.

6. The integrated light source driving circuit according to claim 1, wherein the power transistor further comprises:
a termination region disposed to encircle the substrate, the first active region and the second active region.

7. The integrated light source driving circuit according to claim 1, further comprising:
a lead frame having a chip base and a plurality of pads, the plurality of pads being disposed around the chip base, wherein the power transistor is disposed on the chip base and the first active region is disposed toward the chip base.

8. The integrated light source driving circuit according to claim 7, wherein a cathode of the diode is electrically connected to at least a first one of the plurality of pads, the first active region is electrically connected to at least a second one of the plurality of pads, and the second active region is electrically connected to at least a third one of the plurality of pads.

9. The integrated light source driving circuit according to claim 1, wherein the power transistor is a vertical double-diffused MOS (VDMOS), the first active region is a drain of the VDMOS, the second active region is a source of the VDMOS, and the gate region is a gate of the VDMOS.

10. The integrated light source driving circuit according to claim 1, wherein the power transistor is an insulated gate bipolar transistor (IGBT), the first active region is a collector of the IGBT, the second active region is an emitter of the IGBT, and the gate region is a gate of the IGBT.

11. A light source module, comprising:
an integrated light source driving circuit, comprising:
a power transistor comprising a substrate, a first active region, a second active region, a gate region, and an isolation region, the first active region and the second active region being disposed at two opposite sides of the substrate, the second active region and the gate region being disposed at a same side of the substrate, the isolation region and the first active region being electrically connected, and the isolation region being electrically independent from the second active region and the gate region;
a driving chip stacked on the second active region of the power transistor and electrically connected to the gate region; and
a diode disposed in an isolation region of the power transistor, wherein an anode of the diode is disposed toward the isolation region to be electrically connected to the first active region;
a resonant circuit electrically connected to an anode of the diode and the first active region; and
a light emitting unit electrically connected to a cathode of the diode.

12. The light source module according to claim 11, wherein the integrated light source driving circuit further comprises:
a lead frame having a chip base and a plurality of pads, the plurality of pads disposed around the chip base, wherein the power transistor is disposed on the chip base, and the first active region is disposed toward the chip base.

13. The light source module according to claim 12, wherein the plurality of pads comprise at least a first pad, at least a second pad, and at least a third pad, a cathode of the diode is electrically connected to the light emitting unit via the first pad, the first active region is electrically connected to the resonant circuit via the second pad, and the second active region is electrically connected to a ground via the third pad.
